(19) United States
(12) Patent Application Publication
(10) Pub. No.: US 2023/0094821 A1
(43) Pub. Date: Mar. 30, 2023

(54) VOLUMETRIC THREE-DIMENSIONAL PRINTING METHODS INCLUDING A LIGHT SHEET AND SYSTEMS

(71) Applicant: QUADRATIC 3D, INC., CHARLESTOWN, MA (US)

(72) Inventors: Karen TWIETMEYER, Belmont, MA (US); Peter T. Kazlas, Sudbury, MA (US); Samuel N. Sanders, Arlington, MA (US); Daniel N. Congreve, Palo Alto, CA (US)

(21) Appl. No.: 18/073,702

(22) Filed: Dec. 2, 2022

Related U.S. Application Data
(63) Continuation of application No. PCT/US2021/035791, filed on Jun. 3, 2021.
(60) Provisional application No. 63/034,184, filed on Jun. 3, 2020.
(60) Provisional application No. 63/034,164, filed on Jun. 3, 2020.

(51) Int. Cl. B29C 64/277; B29C 64/135; B33Y 10/00; B33Y 30/00

(52) U.S. Cl. CPC B29C 64/277; B29C 64/135; B33Y 10/00; B33Y 30/00

(57) ABSTRACT

The present invention relates to methods and systems for volumetric printing a three-dimensional object. The methods and systems include achieving polymerization in a photopolymerizable liquid at the intersection of a first optical projection of excitation light and second optical projection of excitation light comprising a sheet of excitation light.

### CROSS-REFERENCE TO RELATED APPLICATIONS

This application is a continuation of International Application No. PCT/US2021/035791 filed on Jun. 3, 2021, which International Application claims priority to U.S. Provisional Patent Application No. 63/034,184, filed on Jun. 3, 2020, and U.S. Provisional Patent Application No. 63/034,164, filed on Jun. 3, 2020. Each of the foregoing applications is hereby incorporated herein by reference in its entirety for all purposes.

### TECHNICAL FIELD OF THE INVENTION

The present invention relates to the technical field of three-dimensional (3D) printing.

### BRIEF SUMMARY OF THE INVENTION

In accordance with one aspect of the present invention, there is provided a method of forming a three-dimensional object, the method comprising (a) providing a volume of a photopolymerizable liquid included within a container wherein at least a portion of the container is optically transparent so that the photopolymerizable liquid is accessible by excitation light; (b) directing at least two optical projections of excitation light into the volume of the photopolymerizable liquid, the at least two optical projections of excitation light including a first optical projection of excitation light and a second optical projection of excitation light comprising a sheet of excitation light, wherein each of the first and second optical projections of excitation light is directed into the photopolymerizable liquid in a direction orthogonal to the other and the sheet of excitation light is orthogonal to the direction in which the first optical projection of excitation is directed into the volume, wherein each optical projection of excitation light has an excitation intensity and excitation wavelength so that local polymerization is achieved at the intersection of optical projections of excitation light; and (c) optionally repeating step b, until the three dimensional object is formed.

In accordance with another aspect of the present invention, there is provided a method of forming a three-dimensional object, the method comprising: (a) providing a volume of a photopolymerizable liquid included within a container wherein at least a portion of the container is optically transparent so that the photopolymerizable liquid is accessible by excitation light; (b) selectively directing at least two optical projections of excitation light into the volume of the photopolymerizable liquid, the at least two optical projections of excitation light including a first optical projection of excitation light comprising a two-dimensional image and a second optical projection of excitation light comprising a sheet of excitation light, wherein each of the first and second optical projections of excitation light is directed into the volume of the photopolymerizable liquid in a direction orthogonal to the direction of the other and the sheet of excitation light is orthogonal to the direction in which the first optical projection of excitation is directed into the volume, and wherein each optical projection of excitation light has an excitation intensity and excitation wavelength so that local polymerization is achieved at the intersection of the first and second optical projections of excitation light; and (c) optionally repeating step b until the three-dimensional object is formed.

In accordance with still another aspect of the present invention, there is provided a method of forming a three-dimensional object, the method comprising: (a) providing a volume of an upconverting photopolymerizable liquid included within a container wherein at least a portion of the container is optically transparent so that the upconverting photopolymerizable liquid is accessible by excitation light, and wherein the upconverting photopolymerizable liquid comprises: (i) a photopolymerizable component; (ii) an upconverting component that emits upconverted light upon excitation by the excitation light, the emitted light exciting a photoinitiator; and (iii) the photoinitiator that initiates polymerization of the photopolymerizable component upon excitation by light emitted by the upconverting component; (b) directing at least two separate optical projections of excitation light into the volume of the upconverting photopolymerizable liquid, the at least two separate optical projections of excitation light including a first optical projection of excitation light comprising a two-dimensional optical image, the first optical projection of excitation light being projected from a first optical projection system, and a second optical projection of excitation light comprising a line of excitation light that passes through the photopolymerizable liquid to form a sheet of excitation light, the second optical projection of excitation light being projected from a second optical projection system including a spatial light modulator, wherein each of the first and second optical projections of excitation light is directed into the upconverting photopolymerizable liquid in a direction orthogonal to the other, and wherein each of the first and second optical projections of excitation light has an intensity and wavelength so that local polymerization is achieved at the intersection of the first and second optical projections of excitation light in the upconverting photopolymerizable liquid; and (c) optionally repeating step b until the three-dimensional object is formed.

In accordance with yet another aspect of the present invention, there is provided a method of forming a three-dimensional object, the method comprising: (a) providing a volume of an upconverting photopolymerizable liquid included within a container wherein at least a portion of the container is optically transparent so that the upconverting photopolymerizable liquid is accessible by excitation light, and wherein the upconverting photopolymerizable liquid comprises: (i) a photopolymerizable component; (ii) an upconverting component for absorbing light at a first wavelength and emitting light at a second wavelength, the second wavelength being shorter than the first wavelength; and (iii) a photoinitiator that initiates polymerization of the photopolymerizable component upon excitation by light at the second wavelength; (b) directing at least two separate optical projections of excitation light into the volume of the upconverting photopolymerizable liquid, the at least two separate optical projections of excitation light including a first optical projection of excitation light comprising a two-dimensional optical pattern comprising a cross-sectional plane of the three-dimensional object, the first optical projection of excitation light being projected from a first optical projection system comprising a spatial light modulator and a second optical projection of excitation light comprising a sheet of excitation light, the sheet of excitation light being generated by a second optical projection system comprising a spatial light modulator wherein selected elements are turned on in a “line” configuration to create a line of excitation light that is projected through the upconverting photopolymerizable liquid to form the sheet of excitation light, the sheet of excitation light being orthogonal to the direction in which the first optical projection of excitation light is projected, wherein each of the first and second optical projections of excitation light are selectively directed into the upconverting photopolymerizable liquid in a direction orthogonal to the other, and wherein each of the first and second optical projections of excitation light has an intensity and wavelength so that local polymerization is achieved at the intersection of the first and second optical projections of excitation light; and (c) optionally repeating step b until the three-dimensional object is formed.

The methods of the invention can further comprise removing the formed three-dimensional object from the container. Following removal from the container, the completed object can be further processed. Examples of further processing include, without limitation, a post-curing step to complete any partial polymerization, washing the formed three-dimensional object, packaging, etc.

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description and drawings, from the claims, and from practice of the invention disclosed herein.

### BRIEF DESCRIPTION OF THE DRAWINGS

In the drawings,

FIG. 1 schematically depicts an example of an aspect of the invention including two optical projection systems with each of the systems directing a separate optical projection of excitation light into a photopolymerizable liquid in a direction that is orthogonal to that of the other, one of the projections being a two-dimensional patterned image and one of the projections being a sheet of excitation light.

FIG. 2 schematically depicts an example of an aspect of the invention including two optical projection systems with each of the systems directing a collimated optical projection of excitation light into a photopolymerizable liquid in a direction that is orthogonal to that of the other, one of the projections being a two-dimensional patterned image and one of the projections being a sheet of excitation light.

FIG. 3 schematically depicts an example of an aspect of the invention including two optical projection systems with each of the systems directing an optical projection of excitation light into a photopolymerizable liquid in a direction that is orthogonal to that of the other, one of the projections being a focused two-dimensional patterned image and one of the projections being a collimated sheet of excitation light.

FIGS. 4A-C schematically depicts different views of a diagram showing the directions of projections of first and second optical projections of excitation light for an example of an aspect of the invention.

FIGS. 5A-C schematically depicts different views of a diagram showing the directions of projections of first and second optical projections of excitation light for an example of an aspect of the invention.

FIGS. 6A-C schematically depicts different views of a diagram showing the directions of projections of first and second optical projections of excitation light for an example of an aspect of the invention.

FIGS. 7A-C schematically depicts different views of a diagram showing the directions of projections of first and second optical projections of excitation light for an example of an aspect of the invention.

FIG. 8 schematically depicts an example of a method and system in accordance with one or more aspects of the invention including a first optical projection system including focused illumination and a second optical projection system including collimated illumination.

FIG. 9 schematically depicts an example of a method and system in accordance with one or more aspects of the invention including a first optical projection system including collimated illumination and a second optical projection system including collimated illumination.

FIGS. 10A & B provide charts outlining examples of first and second optical systems for use in methods and systems in accordance with one or more aspects of the invention.

The attached figures are simplified representations presented for purposes of illustration only; the actual structures may differ in numerous respects, particularly including the relative scale of the articles depicted and aspects thereof.

For a better understanding to the present invention, together with other advantages and capabilities thereof, reference is made to the following disclosure and appended claims in connection with the above-described drawings.

### DETAILED DESCRIPTION OF THE INVENTION

Various aspects and embodiments of the present inventions will be further described in the following detailed description.

The present invention relates to methods and systems for volumetric printing a three-dimensional object. The methods and systems include achieving polymerization in a photopolymerizable liquid at the intersection of a first optical projection of excitation light and second optical projection of excitation light comprising a sheet of excitation light.

In accordance with one aspect of the present invention, there is provided a method of forming a three-dimensional object, the method comprising (a) providing a volume of a photopolymerizable liquid included within a container wherein at least a portion of the container is optically transparent so that the photopolymerizable liquid is accessible by excitation light; (b) directing at least two optical projections of excitation light into the volume of the photopolymerizable liquid, the at least two optical projections of excitation light including a first optical projection of excitation light and a second optical projection of excitation light comprising a sheet of excitation light, wherein each of the first and second optical projections of excitation light is directed into the photopolymerizable liquid in a direction orthogonal to the other and the sheet of excitation light is orthogonal to the direction in which the first optical projection of excitation is directed into the volume, wherein each optical projection of excitation light has an excitation intensity and excitation wavelength so that local polymerization is achieved at the intersection of optical projections of excitation light; and (c) optionally repeating step b, preferably directing the first and second optical projections of excitation light to selected regions within the photopolymerizable liquid, until the three-dimensional object is formed.

In accordance with another aspect of the present invention, there is provided a method of forming a three-dimensional object, the method comprising: (a) providing a volume of a photopolymerizable liquid included within a container wherein at least a portion of the container is optically transparent so that the photopolymerizable liquid is accessible by excitation light; (b) selectively directing at least two optical projections of excitation light into the volume of the photopolymerizable liquid, the at least two optical projections of excitation light including a first optical projection of excitation light comprising a two-dimensional image and a second optical projection of excitation light comprising a sheet of excitation light, wherein each of the first and second optical projections of excitation light is directed into the volume of the photopolymerizable liquid in a direction orthogonal to the direction of the other and the sheet of excitation light is orthogonal to the direction in which the first optical projection of excitation is directed into the volume, and wherein each optical projection of excitation light has an excitation intensity and excitation wavelength so that local polymerization is achieved at the intersection of the first and second optical projections of excitation light; and (c) optionally repeating step b, preferably directing the first and second optical projections of excitation light to selected regions within the photopolymerizable liquid, until the three-dimensional object is formed.

In accordance with still another aspect of the present invention, there is provided a method of forming a three-dimensional object, the method comprising: (a) providing a volume of an upconverting photopolymerizable liquid included within a container wherein at least a portion of the container is optically transparent so that the upconverting photopolymerizable liquid is accessible by excitation light, and wherein the upconverting photopolymerizable liquid comprises: (i) a photopolymerizable component; (ii) an upconverting component that emits upconverted light upon excitation by the excitation light, the emitted light exciting a photoinitiator; and (iii) the photoinitiator that initiates polymerization of the photopolymerizable component upon excitation by light emitted by the upconverting component; (b) directing at least two separate optical projections of excitation light into the volume of the upconverting photopolymerizable liquid, the at least two separate optical projections of excitation light including a first optical projection of excitation light comprising a two-dimensional optical image, the first optical projection of excitation light being projected from a first optical projection system, and a second optical projection of excitation light comprising a sheet of excitation light generated by projecting a line of excitation light through the upconverting photopolymerizable liquid, the second optical projection of excitation light being projected from a second optical projection system including a spatial light modulator wherein each of the first and second optical projections of excitation light is directed into the upconverting photopolymerizable liquid in a direction orthogonal to the other, and wherein each of the first and second optical projections of excitation light has an intensity and wavelength so that local polymerization is achieved at the intersection of the first and second optical projections of excitation light in the upconverting photopolymerizable liquid; and (c) optionally repeating step b, preferably directing the first and second optical projections of excitation light to selected regions within the photopolymerizable liquid, until the three-dimensional object is formed.

In an optional repeated step b, the first optical projection of excitation light can comprise a successive two-dimensional optical image and the second optical projection of excitation light comprises a successive line of excitation light that passes through the photopolymerizable liquid to form a successive sheet of excitation light.

In accordance with yet another aspect of the present invention, there is provided a method of forming a three-dimensional object, the method comprising: (a) providing a volume of an upconverting photopolymerizable liquid included within a container wherein at least a portion of the container is optically transparent so that the upconverting photopolymerizable liquid is accessible by excitation light, and wherein the upconverting photopolymerizable liquid comprises: (i) a photopolymerizable component; (ii) an upconverting component for absorbing light at a first wavelength and emitting light at a second wavelength, the second wavelength being shorter than the first wavelength; and (iii) a photoinitiator that initiates polymerization of the photopolymerizable component upon excitation by light at the second wavelength; (b) directing at least two separate optical projections of excitation light into the volume of the upconverting photopolymerizable liquid, the at least two separate optical projections of excitation light including a first optical projection of excitation light comprising a two-dimensional optical pattern comprising a cross-sectional plane of the three-dimensional object, the first optical projection of excitation light being projected from a first optical projection system comprising a spatial light modulator and a second optical projection of excitation light comprising a sheet of excitation light, the sheet of excitation light being generated by a second optical projection system comprising a spatial light modulator wherein selected elements are turned on in a “line” configuration to create a line of excitation light that is projected through the upconverting photopolymerizable liquid to form the sheet of excitation light, the sheet of excitation light being orthogonal to the direction in which the first optical projection of excitation light is projected, wherein each of the first and second optical projections of excitation light are selectively directed into the upconverting photopolymerizable liquid in a direction orthogonal to the other, and wherein each of the first and second optical projections of excitation light has an intensity and wavelength so that local polymerization is achieved at the intersection of the first and second optical projections of excitation light; and (c) optionally repeating step b, preferably directing the first and second optical projections of excitation light to selected regions within the photopolymerizable liquid, until the three-dimensional object is formed.

In an optional repeated step b, the first optical projection of excitation light can comprise a successive cross-sectional plane of the three-dimensional object being printed and the second optical projection of excitation light can comprise a successive sheet of excitation light generated by projecting a successive line of excitation light that passes through the photopolymerizable liquid to form a successive sheet of excitation light., the successive line being created by turning off the micromirrors for the preceding “line” configuration and turning on the micromirrors for the successive “line” configuration.

The methods of the invention can further comprise removing the formed three-dimensional object from the container. Following removal from the container, the completed object can be further processed. Examples of further processing include, without limitation, a post-curing step to complete any partial polymerization, washing the formed three-dimensional object, packaging, etc.

The methods described herein can be used to form a three-dimensional object in a layer-by-layer or plane by plane manner by polymerizing a cross-sectional plane of the desired three-dimensional object one at a time, preferably starting at a location remote from the first optical projection system and then forming successive layers, preferably sequentially, approaching the first optical projection system along its projection direction.

In the method described herein, an optical projection of excitation light can preferably also be orthogonal to a wall of the container.

In the methods described herein, step c can comprise repeating step b, preferably directing the first and second optical projections of excitation light to a selected location within the photopolymerizable liquid until the three-dimensional object is formed, wherein the first optical projection of excitation light can comprise the next cross-sectional plane (or successive layer) of the three-dimensional object being printed and the second optical projection of excitation light comprises a sheet of excitation light that intersects with the first projection at the selected location.

The present invention advantageously facilitates faster printing speeds, higher axial resolution of features of the printed three-dimensional object and reducing or eliminating the number of moving parts in the printing system.

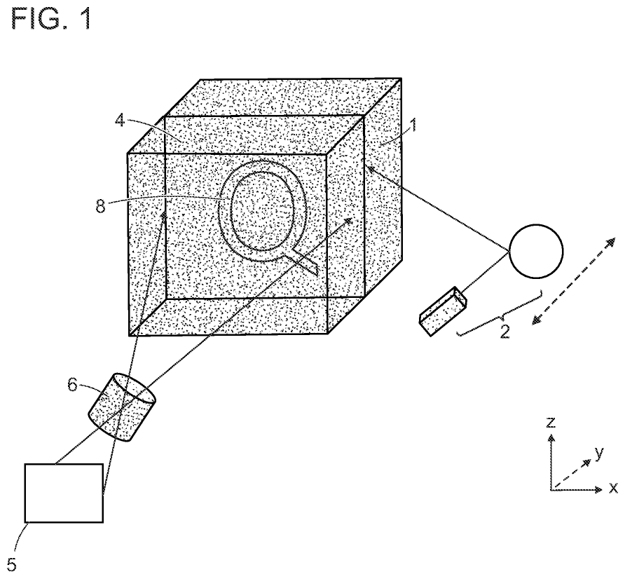

FIG. 1 schematically illustrates an example of a method in accordance with one or more aspects of the invention. In the depicted example, two optical projections of excitation light include a two-dimensional image (depicted as “Q”) and a two-dimensional unpatterned sheet of excitation light 4. Each of the two optical projections of excitation light are directed into the volume of photopolymerizable liquid 1 in a direction orthogonal to each other. In the depicted example, the sheet of excitation light 4 is created in a two-dimensional plane (e.g., the x-z plane) of the volume by a laser and polygon scanner. The sheet of excitation light created by a laser and polygon scanner can be moved in the y-direction by additional scanning means or moving the laser-mirror 2 subsystem. In the depicted example, the two-dimensional image of “Q” is generated by a first optical projection system 5, e.g., a spatial light modulator, and projected with projection optics 6 along the projection axis of the two-dimensional image into the volume of photopolymerizable liquid 1. In the depicted example, the two-dimensional image is projected in the y-direction. Polymerization of the photopolymerizable liquid and formation of a layer of the three-dimensional object being printed occurs where the orthogonal two-dimensional image and sheet of excitation light intersect or overlap, e.g., in the same plane. At the intersection, the sheet of excitation light activates the projection of the two dimensional image of “Q” 8 by creating sufficient intensity to polymerize a layer of the three dimensional “Q” object being printed, While the container in which the photopolymerizable liquid is contained is not shown, the walls of the container facing the optical projection system would include optically transparent portions positioned so that the optical projections of excitation light can pass into the volume of photopolymerizable liquid. (The x, y, z orientation for the system configuration is also shown.)Preferably the orthogonal optical projections of excitation light do not intersect during printing except at one or more desired locations in the volume of the photopolymerizable liquid.

The combined intensity of the intersecting optical projections of excitation light is preferably sufficient to locally polymerize the photopolymerizable liquid at the desired location at which they intersect. More preferably, a single optical projection of excitation light has an intensity that is insufficient to cause polymerization of the photopolymerizable liquid. Most preferably, photopolymerization results only at the intersection of the projections.

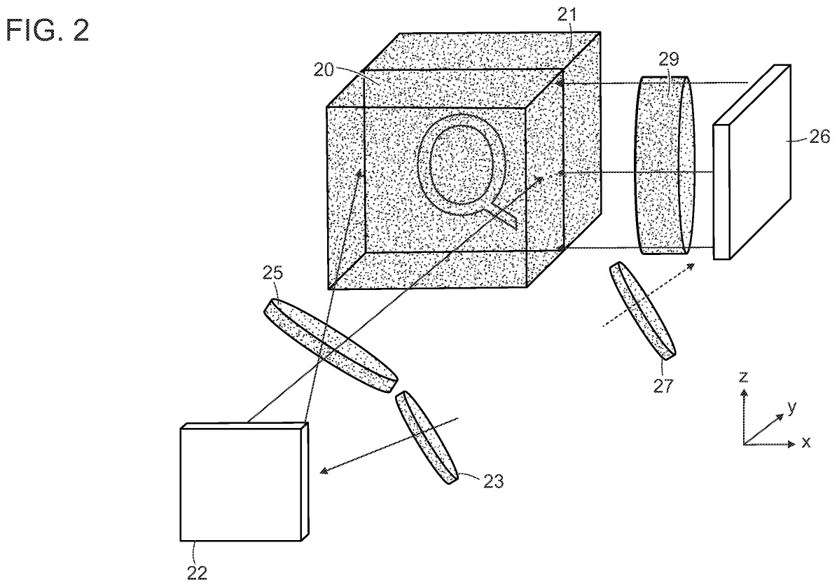

FIG. 2 schematically illustrates another example of a method in accordance with one or more aspects of the invention. In the depicted example, two optical projections of excitation light include a first optical projection comprising a two-dimensional image (depicted as “Q”) and a second optical projection comprising a two-dimensional unpatterned sheet of excitation light” 20. Each of the first and second optical projections of excitation light are directed into the volume of photopolymerizable liquid 21 in a direction orthogonal to each other.

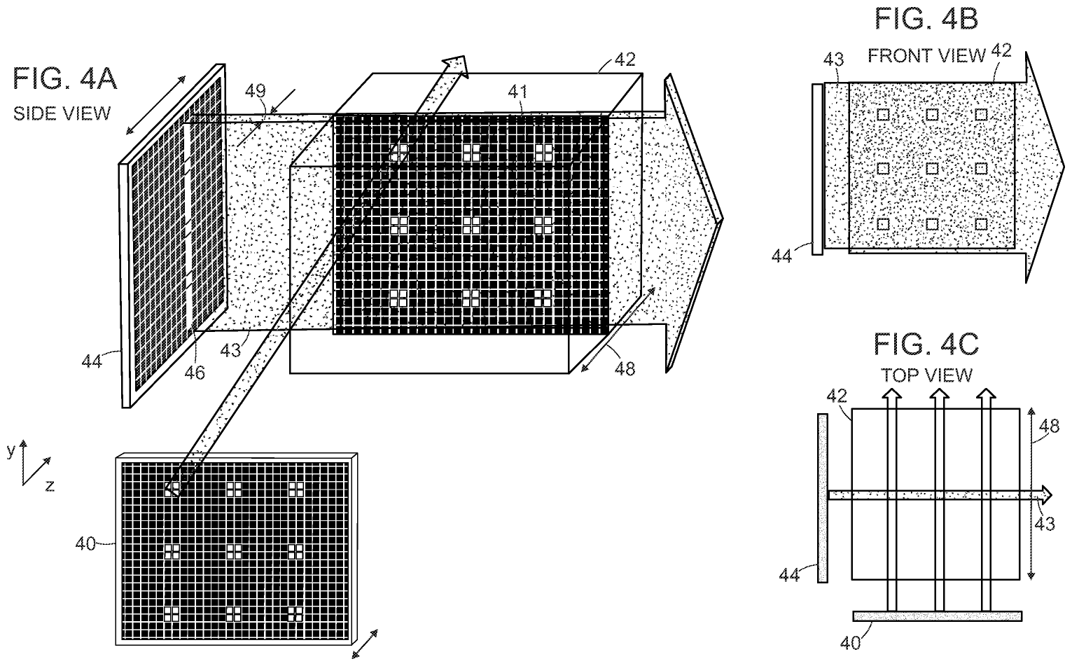

In the depicted example, the second projection of excitation light comprising the sheet of excitation light is created in a two-dimensional plane orthogonal to the projection axis for the first optical projection. The sheet of light is generated by a second spatial light modulator 26, for example, a spatial light modulator, using collimated illumination 27 by projecting a collimated line of excitation light with projection optics 29 that passes through the volume of photopolymerizable liquid. The light sheet is created by projecting the collimated line of excitation light through the photopolymerizable liquid. The line can be created by activating selected elements of, for example, a second spatial light modulator in a line configuration. As depicted, a collimated two-dimensional image of “Q” is generated in a two-dimensional plane orthogonal to its projection axis (e.g., the x-z plane) by a first optical projection 22, e.g., a spatial light modulator, with collimated illumination 23 and projected with projection optics 25 along its projection axis (e.g., the y axis in the depicted example) and uniformly through the volume of photopolymerizable liquid. Polymerization of the photopolymerizable liquid and formation of a layer of the three-dimensional object being printed occurs where the orthogonal two-dimensional image of “Q” and the sheet of excitation light intersect or overlap. (See also, for example, FIGS. 4A, 5A, 6A, and 7A.) At the intersection, the sheet of excitation light activates the projection of the two-dimensional image of “Q”, for example, by creating sufficient intensity to polymerize a layer of the three dimensional “Q” object being printed. As in FIG. 1, the container in which the photopolymerizable liquid is contained is not shown, but the container used to contain the volume of photopolymerizable liquid would at least include optically transparent portions positioned so that the optical projections of excitation light can pass into the volume of photopolymerizable liquid.

The photopolymerizable liquid described in FIG. 2 can comprise an upconverting photopolymerizable liquid. Photopolymerizable liquids and upconverting photopolymerizable liquids are discussed in detail below. For example, red light can be included in excitation light used with an upconverting component that is activated by red light and emits blue light when a photoinitiator is used that absorbs blue light and causes polymerization. Other wavelengths may be used, depending on the particular upconverting component and photoinitiator included in the upconverting photopolymerizable liquid. The excitation light used to generate the sheet of excitation light can be the same wavelength as the excitation light used to generate the two-dimensional image (power will be higher where the two optical projections intersect) or a different wavelength (if a different wavelength works together with the wavelength of the two-dimensional image to enable photopolymerization). The intensity of either of the two optical projections alone is preferably not sufficient to cause photopolymerization In either case, photopolymerization will most preferably only occur where the two-dimensional image and sheet of excitation intersect, e.g., in the same plane. (The x, y, z orientation for the system configuration is also shown.)

Advantageously, the collimated sheet of excitation light can be moved along the projection axis of the two-dimensional image (e.g., the y axis in the example) by, for example, activating different vertical lines of spatial light modulator elements in turn, facilitating “sweeping” the sheet of excitation light through the volume along the projection axis of the two-dimensional image without the need to translate the optical projection system used to generate it.

Another advantage of using collimated light is that the collimated projection is projected uniformly through the volume of photopolymerizable liquid. The use of collimated excitation light to generate the two-dimensional image also removes the need to translate the first optical projection system during formation of the three-dimensional object. Depending on the length of the distance the collimated projection is projected, the power density may not remain constant across the full length of the distance. In such case, the power density loss can be addressed by known techniques. For example, use of a photopolymerizable liquid that is optically clear can help prevent or reduce power density loss across the projection path distance.

To develop the three-dimensional object, software can be used to coordinate generation of the desired two-dimensional pattern from the first spatial light modulator together with the appropriate line of the second spatial light modulator at each position along the projection axis for the two-dimensional pattern (e.g., y axis in the figure) so that the part is developed plane by plane along such projection axis with high axial resolution. Software can also be used to coordinate translation of the first optical projection.

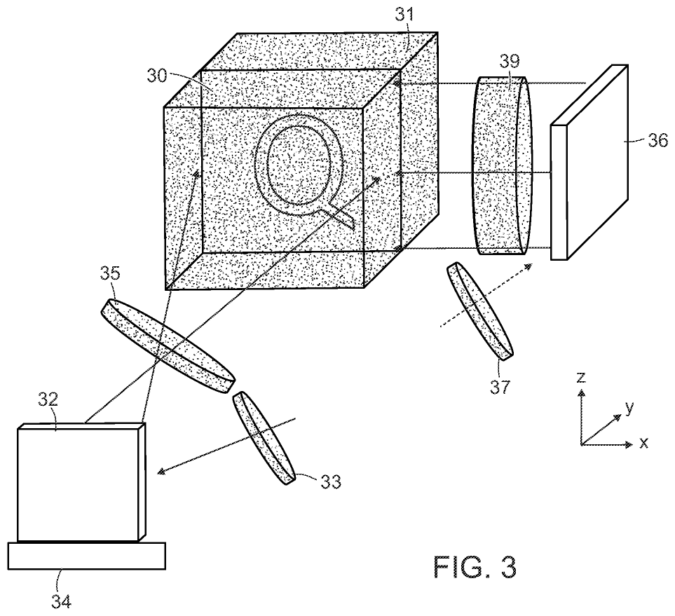

FIG. 3 schematically illustrates another example of a method in accordance with one or more aspects of the invention. In the depicted example, two optical projections of excitation light include a first optical projection of excitation light comprising a two-dimensional image (depicted as “Q”) and a second optical projection of excitation light comprising a two-dimensional unpatterned sheet of excitation light 30. Each of the first and second optical projections of excitation light are directed into the volume of photopolymerizable liquid 31 in a direction orthogonal to each other.

In the depicted example, a first optical projection system 32, e.g., spatial light modulator with focused excitation light 33 generates the first optical projection of excitation light comprising a focused two-dimensional image of “Q” in the x-z plane and projects the focused two-dimensional image with projection optics 35 to a selected position along the projection axis (the y-axis in the depicted example). The position of focus within the volume can be changed by translating the first spatial light modulator using a y-translation stage 34.

In the depicted example, the second optical projection of excitation light comprising a sheet of excitation light 30 is created in the x-z plane of the volume by a second optical projection system 36, e.g., a spatial light modulator, with collimated illumination 37 by projecting a collimated line of excitation light with projection optics 39 through the volume of photopolymerizable liquid. The collimated line of excitation light can be created by activating selected elements of the second spatial light modulator in a line configuration. Polymerization of the photopolymerizable liquid and formation of a layer of the three-dimensional object being printed occurs where the orthogonal two-dimensional image of “Q” and the sheet of excitation light intersect or overlap. At the intersection, the sheet of excitation light activates the projection of the two-dimensional image of “Q” by creating sufficient intensity to polymerize a layer of the three dimensional “Q” object being printed. Again, as in FIG. 1, the container in which the photopolymerizable liquid is contained is not shown, but the container used to contain the volume of photopolymerizable liquid would at least include optically transparent portions positioned so that the optical projections of excitation light can pass into the volume of photopolymerizable liquid. (The x, y, z orientation for the system configuration is also shown.)

The photopolymerizable liquid described in FIG. 3 can comprise an upconverting photopolymerizable liquid. Photopolymerizable liquids and upconverting photopolymerizable liquids are discussed in detail below. An upconverting component included in an upconverting photopolymerizable liquid is excited by an excitation light including a first wavelength and emits light including a second wavelength that activate a photoinitiator (also included in the upconverting photopolymerizable liquid) that absorbs light including the second wavelength to initiate polymerization. For example, red light can be included in excitation light used with an upconverting component that is activated by red light and emits blue light, which can then be absorbed by a photoinitiator that absorbs blue light to initiate polymerization. Other wavelengths may be used, depending on the particular upconverting component and photoinitiator included in the upconverting photopolymerizable liquid. The excitation light used to generate the sheet of excitation light can be the same wavelength as the excitation light used to generate the two-dimensional image (power will be higher where the two optical projections intersect) or a different wavelength (if a different wavelength works together with the wavelength of the two-dimensional image to enable photopolymerization). In either case, photopolymerization will only occur where the two-dimensional image and sheet of excitation intersect.

As discussed above, the collimated sheet of excitation light can advantageously be moved along the projection axis of the two-dimensional image (the y axis in the example), for example, by activating different vertical lines of spatial light modulator elements in turn, facilitating “sweeping” the sheet of excitation light through the volume along the projection axis of the two-dimensional image without the need to translate the optical projection system used to generate it.

In the methods described herein, software can be used to coordinate generation of the desired two-dimensional pattern from the first optical projection system (e.g., a first spatial light modulator) together with the light sheet (e.g., generated from an appropriate line of a second spatial light modulator) at each position along the y axis so that the part is developed plane by plane along the y axis with high axial resolution. Software can also be used to coordinate translation of the first optical projection.

Preferably the orthogonal optical projections of excitation light do not intersect during printing except at one or more desired locations in the volume of the photopolymerizable liquid.

The combined intensity of the intersecting optical projections of excitation light is preferably sufficient to locally polymerize the photopolymerizable liquid at the desired location at which they intersect. More preferably a single optical projection of excitation light has an intensity that is insufficient to initiate polymerization of the photopolymerizable liquid. Most preferably, polymerization occurs only at the intersection of the optical projections.

FIGS. 4A, 4B, and 4C schematically depicts different views of a diagram showing an example of the orthogonal orientation of projections of first and second optical projections of excitation light for one or more aspects of the invention that include first and second optical projection generated with collimated light.

FIG. 4A schematically depicts a side view of a diagram showing an example of the orthogonal orientation of projections of first and second optical projections of excitation light, for one or more aspects of the invention, showing the first 40 and second 44 optical projection system with selected pixels turned on and showing the intersection 41 of the first and second optical projections at a selected location in the photopolymerizable liquid. In the depicted example, the first and second optical projections of excitation light are generated by first 40 and second 44 optical projection systems which each include, for example, a spatial light modulator such as a digital micromirror device. FIG. 4A shows a first optical projection of excitation light comprising a two-dimensional patterned image generated with collimated light inro the volume of the photopolymerizable liquid. The beam trajectory for one group of “on” pixels is shown by an arrow. The image is generated in the depicted example with an imaging DMD 40 with selected pixels turned on. The planar face of the two-dimensional patterned image is orthogonal to its projection direction into the photopolymerizable liquid 42.

A second optical projection of excitation light comprising a sheet of excitation light is generated by projecting a line of light from the second optical projection system 44 created by turning on, for example, the spatial light modulator elements in a “line” configuration 46 creating a light sheet 43. Optionally, depending on the particular three-dimensional image being printed, more than one line can be turned on to control axial geometry. The line of excitation light is projected into the volume of photopolymerizable liquid in a direction orthogonal to the projection direction of the first optical projection of excitation light. Preferably, the line of excitation light is generated with collimated light, as depicted in the figure, with the projection of the collimated line forming a sheet of excitation light in the photopolymerizable liquid, the sheet being orthogonal to the projection axis of the first optical projection of excitation light. Polymerization occurs at the intersection of the sheet of excitation light and the two-dimensional patterned image. Because the lateral dimension of the sheet of excitation light 49 can be significantly less than the axial thickness 48 of the collimated two-dimensional patterned image, the axial thickness of the intersection (along the projection axis of the first projection system) is approximately the same as lateral thickness of the line of light and the sheet of excitation light generated therewith, giving rise to improved axial resolution for the resulting polymerized layer. (The y, z orientation for the system configuration is also shown.)

Generating the excitation sheet of light using, for example, a DMD and collimated light advantageously enables the light sheet to be moved or “swept” through the volume of photopolymerizable liquid, along the projection axis of the first optical projection system, by lighting different vertical lines of micromirrors one line (or combinations or groupings of lines of micromirrors) at a time, preferably in a successive (e.g., plane by plane or layer by layer) manner This can eliminate the need to translationally move the second optical projection system to move the light sheet along the projection axis of first optical projection system one at a time.

FIG. 4B depicts the front view of an overlapping light sheet 43 generated by the second projection system 44 and a two-dimensional planar image projected from the first projection system (not shown) in the photopolymerizable liquid 42.

FIG. 4C depicts a top view of the photopolymerizable liquid with the light sheet 43 projected from the second optical projection system 44 through the photopolymerizable liquid and the first optical projection projected from the first optical projection system 40 through the volume of the photopolymerizable liquid 42 in a projection direction orthogonal to the major face of the light sheet. The axial resolution 48 of the collimated first optical projection is also shown. As mentioned above, the axial thickness of the intersection (along the projection axis of the first optical projection system) is approximately the same as lateral thickness of the line of light and the sheet of excitation light 43 generated therewith.

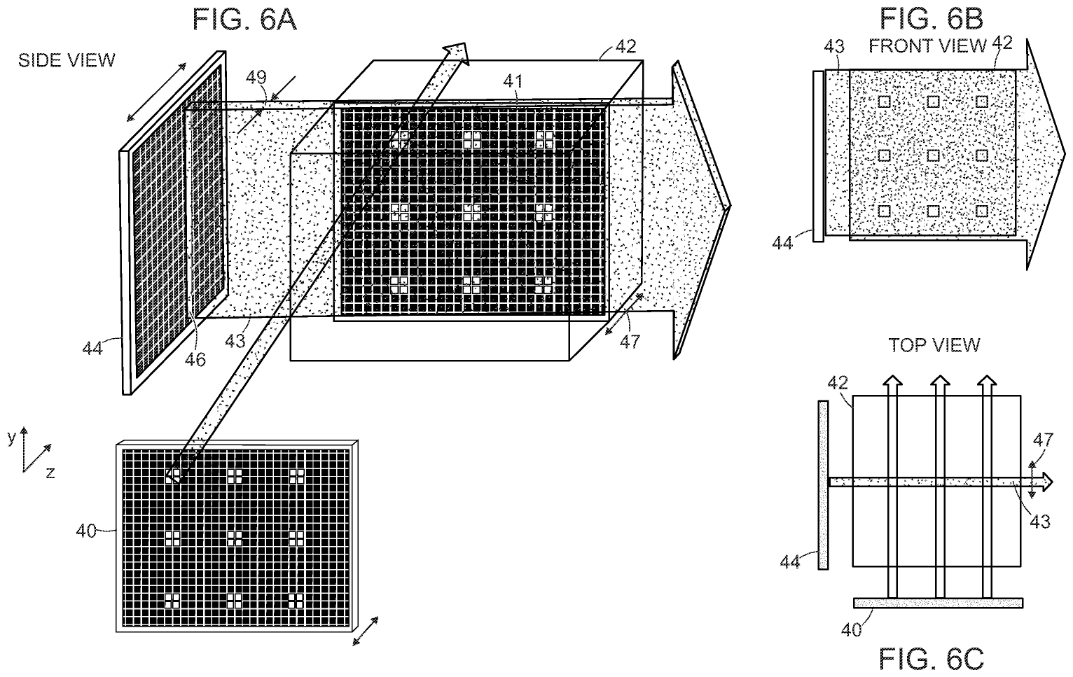

FIGS. 6A, 6B, and 6C schematically depicts different views of a diagram showing an example of the orthogonal orientation of projections of first and second optical projections of excitation light for one or more aspects of the invention that include a first optical projection generated with focused light and a second optical projection generated with collimated light. When the first optical projection is focused, it can be translationally moved along the projection axis to change its position in the photopolymerizable liquid. (A translational stage is not shown.)

FIG. 6A shows a first 40 and second 44 optical projection system with selected pixels turned on and shows the intersection 41 of the first and second optical projections at a selected location in the photopolymerizable liquid. In the depicted example, the first and second optical projections of excitation light are generated by first 40 and second 44 optical projection systems which each include, for example, a spatial light modulator such as a digital micromirror device. FIG. 6A shows a first optical projection of excitation light comprising a two-dimensional patterned image generated with focused light into the volume of the photopolymerizable liquid. The beam trajectory for one group of “on” pixels of the image is shown by an arrow. The image is generated in the depicted example by a first optical projection system that includes, for example, an imaging DMD with selected pixels turned on. The planar face of the two-dimensional patterned image is orthogonal to its projection direction into the photopolymerizable liquid 42.

A second optical projection of excitation light comprising a sheet of excitation light is generated by projecting a line of light from the second optical projection system 44 created by turning on, for example, the spatial light modulator elements in a “line” configuration 46 creating a light sheet 43. Optionally, depending on the particular three-dimensional image being printed, more than one line can be turned on to control axial geometry. The line of excitation light is projected into the volume of photopolymerizable liquid in a direction orthogonal to the projection direction of the first optical projection of excitation light. Preferably, the line of excitation light is generated with collimated light, as depicted in the figure, with the projection of the collimated line forming a sheet of excitation light in the photopolymerizable liquid, the sheet being orthogonal to the projection axis of the first optical projection of excitation light. Polymerization occurs at the intersection of the sheet of excitation light and the two-dimensional patterned image. Because the lateral dimension of the sheet of excitation light 49 can be significantly less than the axial thickness 47 of the focused two-dimensional patterned image, the axial thickness of the intersection (along the projection axis of the first optical projection system) is approximately the same as lateral thickness of the line of light and the sheet of excitation light generated therewith, giving rise to improved axial resolution for the resulting polymerized layer. (The y, z orientation for the system configuration is also shown.)

FIG. 6B depicts the front view of an overlapping light sheet 43 generated by the second projection system 44 and a two-dimensional planar image projected from the first projection system (not shown) in the photopolymerizable liquid 42.

FIG. 6C depicts a top view of the photopolymerizable liquid with the light sheet 43 projected from the second optical projection system 44 through the photopolymerizable liquid and the first optical projection projected from the first optical projection system 40 through the photopolymerizable liquid 42 in a projection direction orthogonal to the major face of the light sheet. The axial resolution 47 of the focused first optical projection is also shown. As mentioned above, the axial thickness of the intersection (along the projection axis of the first optical projection system) is approximately the same as lateral thickness of the line of light and the sheet of excitation light 43 generated therewith.

A light sheet can comprise a two-dimensional plane generated by projecting a full line of excitation light through the volume of photopolymerizable liquid. FIGS. 4A, 4B, 4C, 6A, 6B, and 6C includes examples of aspects of the invention including a second optical projection comprising a light sheet generated by projecting a full line of excitation light through the volume of photopolymerizable liquid-Alternatively, a light sheet can comprise a partial light sheet or an array of one or more partial light sheets (e.g., stripes or bands of light) generated by, for example, projecting light from only selected segments or selected pixels of a line configuration of spatial light modulator elements. Preferably the selected pixels are in line with (e.g., aligned to intersect with) the illuminated portions (e.g., pixels) that make up the first optical projection projected from the first optical projection system.

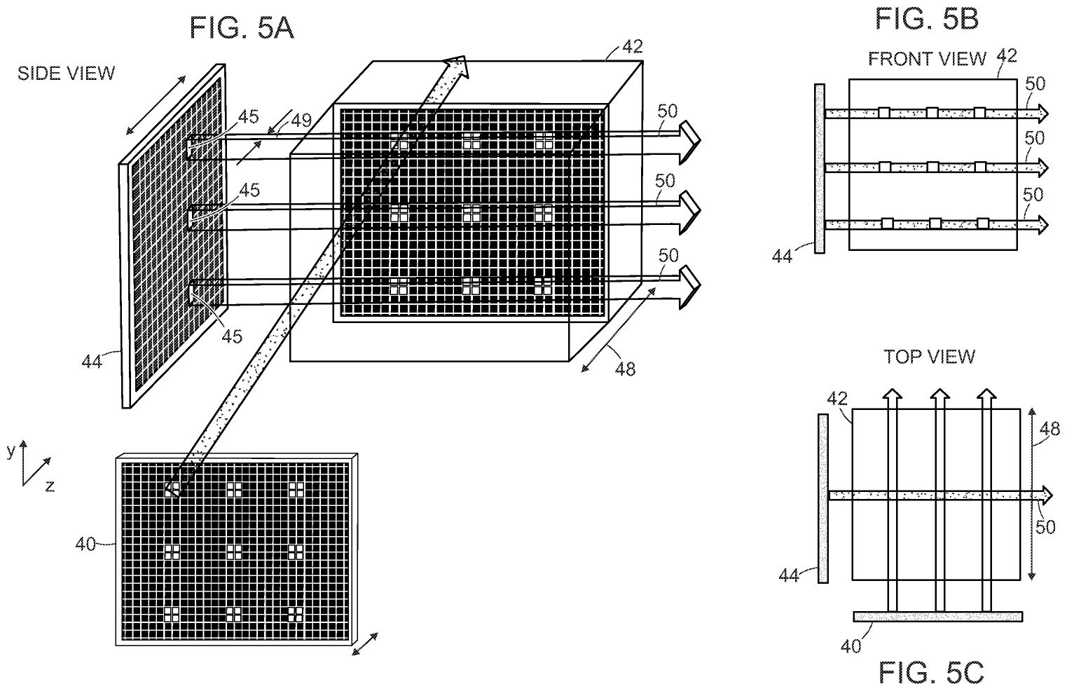

FIGS. 5A, 5B, and 5C schematically depicts different views of a diagram showing an example of the orthogonal orientation of projections of first and second optical projections of excitation light for one or more aspects of the invention that include first and second optical projection generated with collimated light and a second optical projection including an array of partial light sheets.

FIG. 5A schematically depicts a side view of a diagram showing an example of the orthogonal orientation of projections of first and second optical projections of excitation light for one or more aspects of the invention in which the second optical projection comprises an array of partial light sheets. The figure shows a first 40 and second 44 optical projection system with selected pixels turned on and shows the intersection of the first and second optical projections at a selected location in the photopolymerizable liquid. In the depicted example, the first and second optical projections of excitation light are generated by first 40 and second 44 optical projection systems which each include, for example, a spatial light modulator such as a digital micromirror device. FIG. 5A shows a first optical projection of excitation light comprising a two-dimensional patterned image generated with collimated light into the volume of the photopolymerizable liquid. The beam trajectory for one group of “on” pixels is shown by an arrow. The image is generated in the depicted example with an imaging DMD 40 with selected pixels turned on. The planar face of the two-dimensional patterned image is orthogonal to its projection direction into the photopolymerizable liquid 42.

A second optical projection of excitation light comprising an array of partial sheets of excitation light (or light stripes) is generated by projecting one or more segments of a line of light from the second optical projection system 44 created by, for example, turning on selected pixels 45 of a “line” configuration of, for example, spatial light modulator elements creating an array of one or more partial light sheets 50. The figure depicts an array of 3 partial light sheets. Preferably the selected pixels for forming the partial light sheets are in line with the illuminated pixels that make up the first optical projection projected from the first optical projection system, as shown in the figure. Optionally, depending on the particular three-dimensional image being printed, more than one line can be turned on to control axial geometry. The illuminated segments of the line of excitation light are projected into the volume of photopolymerizable liquid in a direction orthogonal to the projection direction of the first optical projection of excitation light. Preferably, the line segments of excitation light are generated with collimated light, as depicted in the figure, with the projection of the collimated line segments forming an array of partial sheets of excitation light in the photopolymerizable liquid, the array of partial light sheets being orthogonal to the projection axis of the first optical projection of excitation light. Polymerization occurs at the intersection of the partial light sheets of the array with the lighted pixels of the two-dimensional patterned image. Because the lateral dimension of the light sheets making up the array 49 can be significantly less than the axial thickness of the collimated two-dimensional patterned image 48, the axial thickness of the intersection (along the projection axis of the imaging DMD) is approximately the same as lateral thickness of the line of light and the sheet of excitation light generated therewith, giving rise to improved axial resolution for the resulting polymerized layer. (The y, z orientation for the system configuration is also shown.)

Generating the array of partial light sheets using, for example, a DMD and collimated light advantageously enables the array of partial light sheets to be moved or “swept” through the volume of photopolymerizable liquid, along the projection axis of the first optical projection system by lighting segments of different vertical lines of micromirrors one line (or combinations or groupings of lines of micromirrors) at a time, preferably in a successive (e.g., plane by plane or layer by layer) manner This can eliminate the need to translationally move the second optical projection system to move the light sheet along the projection axis of first optical projection system one at a time.

FIG. 5B depicts the front view of an overlapping array of light sheets 50 generated by the second projection system 44 and a two-dimensional planar image projected from the first projection system (not shown) in the photopolymerizable liquid 42.

FIG. 5C depicts a top view of the photopolymerizable liquid with an array of light sheets 50 projected from the second optical projection system 44 through the photopolymerizable liquid 42 and the first optical projection projected from the first optical projection system 40 through the photopolymerizable liquid in a projection direction orthogonal to a major face of the array of partial light sheets. The axial resolution 48 of the collimated first optical projection is also shown. As mentioned above, the axial thickness of the intersection (along the projection axis of the first optical projection system) is approximately the same as lateral thickness of the partial light sheets 50.

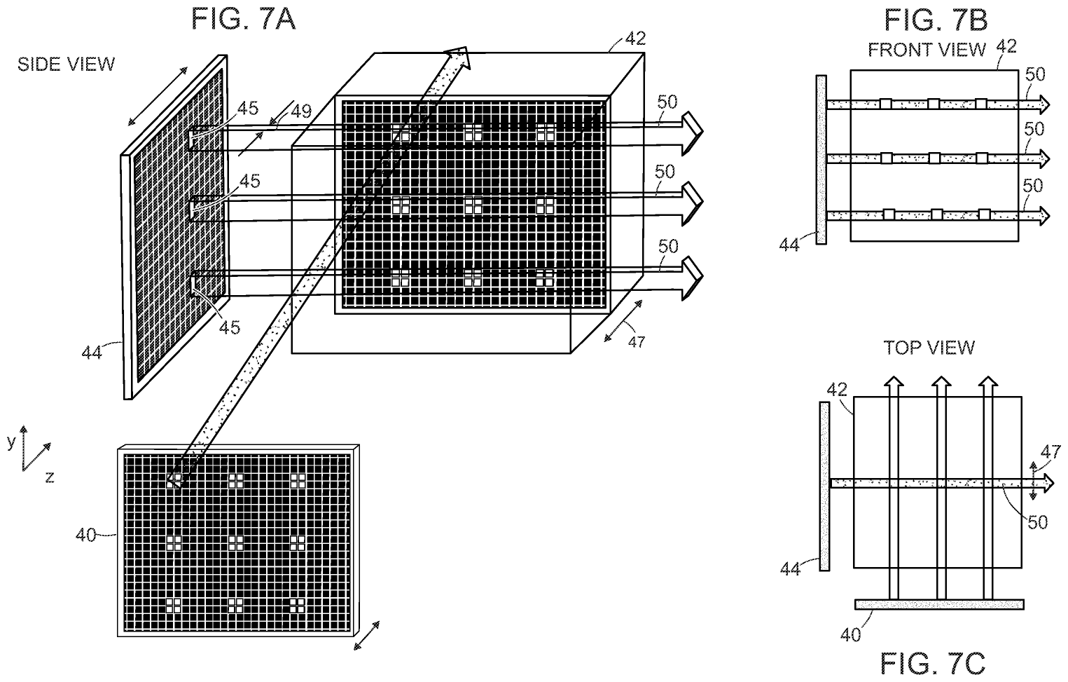

FIGS. 7A, 7B, and 7C schematically depicts different views of a diagram showing an example of the orthogonal orientation of projections of first and second optical projections of excitation light for one or more aspects of the invention that include a first optical projection generated with focused light and a second optical projection generated with collimated light and a second optical projection including an array of partial light sheets.

When an optical projection is focused, it can be translationally moved along the projection axis to change its position in the photopolymerizable liquid.

FIG. 7A schematically depicts a side view of a diagram showing an example of the orthogonal orientation of projections of first and second optical projections of excitation light for one or more aspects of the invention in which the second optical projection comprises an array of partial light sheets. The figure shows a first 40 and second 44 optical projection system with selected pixels turned on and shows the intersection of the first and second optical projections at a selected location in the photopolymerizable liquid. In the depicted example, the first and second optical projections of excitation light are generated by first 40 and second 44 optical projection systems which each include, for example, a spatial light modulator such as a digital micromirror device. FIG. 7A shows a first optical projection of excitation light comprising a two-dimensional patterned image generated with focused light into the volume of the photopolymerizable liquid. The beam trajectory for one group of “on” pixels is shown by an arrow. The image is generated in the depicted example with, for example, an imaging DMD 40 with selected pixels turned on. The planar face of the two-dimensional patterned image is orthogonal to its projection direction into the photopolymerizable liquid 42.

A second optical projection of excitation light comprising an array of partial sheets of excitation light is generated by projecting one or more segments of a line of light from the second optical projection system 44 created by, for example, turning on selected pixels 45 of a “line” configuration of, for example, spatial light modulator elements creating an array of one or more partial light sheets 50. The figure depicts an array of 3 partial light sheets. Preferably the selected pixels for forming the partial light sheets are in line with the illuminated pixels that make up the first optical projection projected from the first optical projection system, as shown in the figure. Optionally, depending on the particular three-dimensional image being printed, more than one line can be turned on to control axial geometry. The illuminated segments of the line of excitation light are projected into the volume of photopolymerizable liquid in a direction orthogonal to the projection direction of the first optical projection of excitation light. Preferably, the line segments of excitation light are generated with collimated light, as depicted in the figure, with the projection of the collimated line segments forming an array of partial sheets of excitation light in the photopolymerizable liquid, the array of partial light sheets being orthogonal to the projection axis of the first optical projection of excitation light. Polymerization occurs at the intersection of the partial light sheets of the array with the lighted pixels of the two-dimensional patterned image. Because the lateral dimension of the light sheets making up the array 49 can be significantly less than the axial thickness of the focused two-dimensional patterned image 47, the axial thickness of the intersection (along the projection axis of the imaging DMD) is approximately the same as lateral thickness of the line of light and the sheet of excitation light generated therewith, giving rise to improved axial resolution for the resulting polymerized layer. (The y, z orientation for the system configuration is also shown.)

Generating the array of partial light sheets using, for example, a DMD and collimated light advantageously enables the array of partial light sheets to be moved or “swept” through the volume of photopolymerizable liquid, along the projection axis of the first optical projection system by lighting segments of different vertical lines of micromirrors one line (or combinations or groupings of lines of micromirrors) at a time, preferably in a successive (e.g., plane by plane or layer by layer)manner This can eliminate the need to translationally move the second optical projection system to move the light sheet along the projection axis of first optical projection system one at a time.

FIG. 7B depicts the front view of an overlapping array of light sheets 50 generated by the second projection system 44 and a two-dimensional planar image projected from the first projection system (not shown) in the photopolymerizable liquid 42.

FIG. 7C depicts a top view of the photopolymerizable liquid with an array of light sheets 50 projected from the second optical projection system 44 through the photopolymerizable liquid 42 and the first optical projection projected from the first optical projection system 40 through the photopolymerizable liquid in a projection direction orthogonal to a major face of the array of partial light sheets. The axial resolution 47 of the focused first optical projection is also shown. As mentioned above, the axial thickness of the intersection (along the projection axis of the first optical projection system) is approximately the same as the axial resolution 49 of the partial light sheets 50.

Without use of the sheet of excitation light, the lateral resolution of a two-dimensional DMD image is a function of the imaging DMD pixel size and optical system magnification, also taking into account the optical system blur (which can be of the order of the diffraction limit or higher). The axial resolution (or thickness) of the two-dimensional DMD image is a function of the optical system numerical aperture (which can typically be at least 5-10 times higher than the lateral resolution).

With the inclusion of the sheet of excitation light, the axial resolution of a two-dimensional DMD image is now equal to the lateral resolution of the DMD used to generate the sheet of light projecting through the volume of photopolymerizable liquid. The lateral resolution of the DMD used to generate the sheet of light is a function of the pixel size, optical system magnification and the optical system blur, and can be much less than the axial resolution of the imaging DMD. It is the overlap or intersection of the light sheet with the imaging DMD axial resolution that provides sufficient power density for polymerization.

Optical resolution refers to the ability of an optical imaging system to resolve detail in the object being imaged. There are many known metrics that can be used to quantify optical resolution, and the choice of most appropriate metric depends on the type of optical system and its performance requirements.

Lateral resolution refers to the optical resolution in the plane normal to the optical axis. For example, a metric for lateral resolution can be the diameter of the smallest illuminated spot produced by an imaging system in response to a point source of illumination, where diameter is defined as the width of the light distribution where intensity falls below a chosen percentage of the peak value, such as 50%.

Axial resolution refers to the optical resolution along the direction of the optical axis. For example, a metric for axial resolution can be to determine the specific point along the optical axis where the smallest illuminated spot lies, then to take the distance between two specific points closer and farther along the optical axis, where the diameter of the illuminated spot is some chosen factor larger, such as 5x larger, than the diameter of the smallest illuminated spot.

In certain embodiments, light sheet can further activate or enhance polymerization by reducing oxygen, inhibitors, and/or viscosity in the photopolymerizable liquid, and/or by activating second photoinitiator (e.g., of a type activated by light (visible or UV) or heat).

A preferred system for volumetric three-dimensional printing includes a stage for supporting a container including a photopolymerizable medium, two optical projection systems, each comprising a spatial light modulator such as a digital micromirror array, the two optical projection systems being positioned in relation to the stage for projecting optical projections in a direction orthogonal to the stage, and two sets of projection optics, wherein one set of projection optics is positioned between one of the spatial light modulators and the stage, a first light source in combination with high numerical aperture relay optics positioned to illuminate one of the two optical projection systems, and a second light source in combination with low numerical aperture projection optics positioned to illuminate the other of the two optical projection systems, wherein each of the two optical projection systems is adapted for connection to a computer for controlling optical projections therefrom. A light source can include, for example, but not limited to, an LED, a laser, or a filtered lamp.

Projection optics in the methods and systems described herein typically can include one or more lenses and/or mirrors.

Optionally, one or both of the optical projection systems is supported on a stage that is at least translationally movable in one or more of the x, y, and z directions.

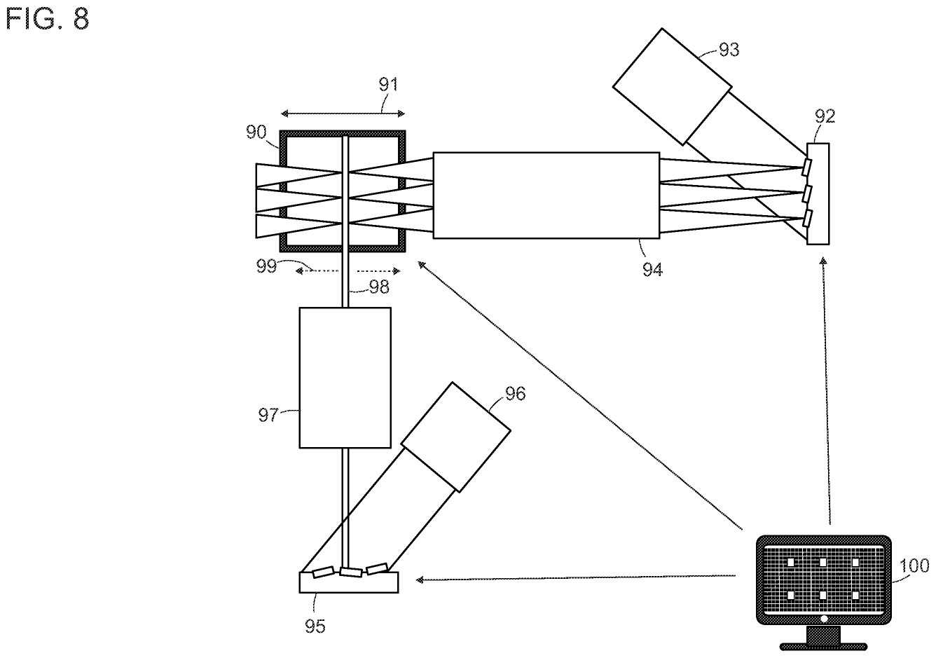

A schematic of an example of a method and system in accordance with one or more aspects of the invention is illustrated in FIG. 8. The depicted system includes a container including a photopolymerizable liquid 90. As depicted, the container is supported on a translation stage (now shown) which can translate the position of the container along the direction indicated by arrow 91. Two optical projection systems 92 and 95 are orthogonally positioned relative to the container and each other, and each directs an optical projection of excitation into the photopolymerizable liquid along an axis orthogonal to the other. Each optical projection of excitation light is preferably also orthogonal to a wall of the container.

In the figure, the first optical projection system includes, for example, a DMD 92, a first light source comprising, for example, an LED light source in combination with focusing relay optics 93 positioned to illuminate the DMD. Projection optics 94 are positioned between the DMD and container for magnifying and projecting a focused first optical projection of excitation light comprising a two-dimensional image into the container.

The second optical projection system includes, for example, a second DMD 95 a second light source comprising, for example, an LED light source in combination with collimated relay optics 96 positioned to illuminate the second DMD. Second projection optics 97 are positioned between the second DMD and container for magnifying and projecting a collimated second optical projection of excitation light comprising a vertical line of excitation light into and through the container. The projection of the line through the photopolymerizable liquid forms a sheet of excitation light 98, the two-dimensional plane of the light sheet being orthogonal to the direction in which the first optical projection is projected into the container. In the example illustrated in the figure, the second DMD projects a collimated line of light generated by turning the DMD micromirrors on in a vertical “line” configuration to project a sheet of excitation light through the photopolymerizable liquid in the container. The first DMD projects a focused two-dimensional image to a specific location in the photopolymerizable liquid in the container, the projections and locations of the two-dimensional image and excitation sheet being coordinated to intersect.

In the example depicted in FIG. 8, the position of the focused two-dimensional image in the photopolymerizable liquid is changed to a different selected position by translational movement of the container along the projection axis. As discussed above, alternatively the DMD could be moved along the projection access to change the position of the focused two-dimensional image in the photopolymerizable liquid.

A computer 100 is also shown. As discussed above, software can be used to coordinate generation of the desired two-dimensional pattern from the first spatial light modulator together with the appropriate line of the second spatial light modulator at each position along the y axis so that the part is developed plane by plane along the y axis with high axial resolution. Selection of computer controls and software is within the skill of the person of ordinary skill in the relevant art.

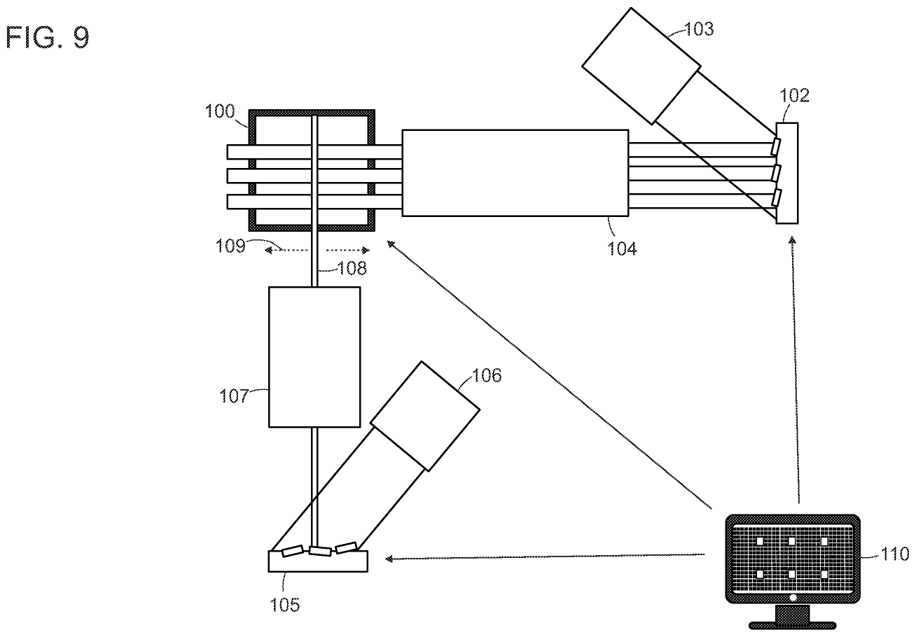

A schematic of another example of a method and system in accordance with one or more aspects of the invention is illustrated in FIG. 9. The depicted system includes a container including a photopolymerizable liquid 100. Two optical projection systems 103 and 105 are orthogonally positioned relative to the container and each other, and each directs an optical projection of excitation into the photopolymerizable liquid along an axis orthogonal to the other. Each optical projection of excitation light is preferably also orthogonal to a wall of the container.

In the figure, the first optical projection system includes, for example, a DMD, a first light source comprising, for example, an LED light source in combination with collimated relay optics 103 positioned to illuminate the DMD. Projection optics 104 are positioned between the DMD and container for magnifying and projecting a collimated first optical projection of excitation light comprising a two-dimensional image into the container.

The second optical projection system includes, e.g., a second DMD, a second light source comprising, for example, an LED light source in combination with collimated relay optics 106 positioned to illuminate the second DMD. Second projection optics 107 are positioned between the second DMD and container for magnifying and projecting a collimated second optical projection of excitation light comprising a vertical line of excitation light into and through the container. The projection of the line through the photopolymerizable liquid forms a sheet of excitation light, the two-dimensional plane (or major face) of the light sheet being orthogonal to the direction in which the first optical projection is projected into the container.

In the example of FIG. 9, the collimated two-dimensional image is projected through the volume of the photopolymerizable liquid without requiring translational movement of the first optical projection system or the container to translate the image along the projection axis.

“Intensity”, as it relates to excitation light, is also referred to herein as power density.

The excitation light of the first and second optical projections is preferably selected so that polymerization can be achieved at the intersection thereof.

As mentioned above, the present invention advantageously facilitates faster printing speeds, higher resolution of features of the printed three-dimensional object, and reducing or eliminating the number of moving parts in the printing system.

The present invention also advantageously facilitates printing three-dimensional objects in a volume of photopolymerizable liquid at a distance or depth of about 1 cm or greater from the interface of the photopolymerizable liquid and the inside surface of the container in which it is contained.

The present invention advantageously further does not require adhering the object being printed to a fixed substrate (e.g., build plate) at the beginning of the printing process avoiding a post-processing step of separating the printed object from the fixed substrate.

The present invention advantageously yet further facilitates printing three-dimensional objects in a volume of photopolymerizable liquid without requiring support structures to form a printed object.

Post-processing steps of removing support structures and/or removing the printed object from a fixed substrate add labor (e g, manual removal), waste (discarded support structures), and reduce throughput (a build plate cannot be reused until the printed object is removed), all of which add cost to the process.

The term “voxel” is used herein to refer to the volume at a location in the photopolymerizable liquid where polymerization may occur.

A voxel may have a size dimension in a range, including but not limited to, from about 5 microns to about 2 centimeters, from about 5 to about 10 microns, and from about 1 centimeter to about 2 centimeters. The range of voxel sizes that can be achieved is much wider than the above listed examples. Other ranges may also be achieved and used.

With, for example, an optical projection system comprising a spatial light modulator, voxel size can be changed by changing the amount of ON pixels.

The individual optical projections of excitation light are preferably selectively directed into the volume of photopolymerizable liquid to print or form the desired three-dimensional object.

Preferably the optical projections of excitation light can be simultaneously directed into the volume of the photopolymerizable liquid.

An optical projection of excitation light can comprise an image, a two-dimensional image, a patterned image, a patterned two-dimensional image, a line of light, or a single point of light. A two-dimensional image can comprise a cross-sectional plane of the three-dimensional image being printed. The methods described herein can further comprise carrying out step c to achieve polymerization of the photopolymerizable liquid at one or more additional regions within the volume of the photopolymerizable liquid until the three-dimensional object is formed.

The methods described herein can further comprise removing the formed three-dimensional object from the container. Following removal from the container, the completed object can be further processed. Examples of further processing include, without limitation, a post-curing step to complete any partial polymerization, washing the formed three-dimensional object, packaging, etc.

Examples of optical projection systems for use in the methods described herein may include, but are not limited to, a laser projection system, a liquid crystal display (also referred to herein as “LCD”), a spatial light modulator (also referred to herein as “SLM”) (for example, but not limited to, a digital micromirror device (also referred to herein as “DMD”)), a micro-LED array, a vertical cavity laser array (also referred to herein as “VCL”), a Vertical Cavity Surface Emitting Laser array (also referred to herein as “VCSEL”), a liquid crystal on silicon (also referred to herein as “LCoS”) projector, and a scanning laser system. (Light emitting diode is also referred to herein as “LED”.)

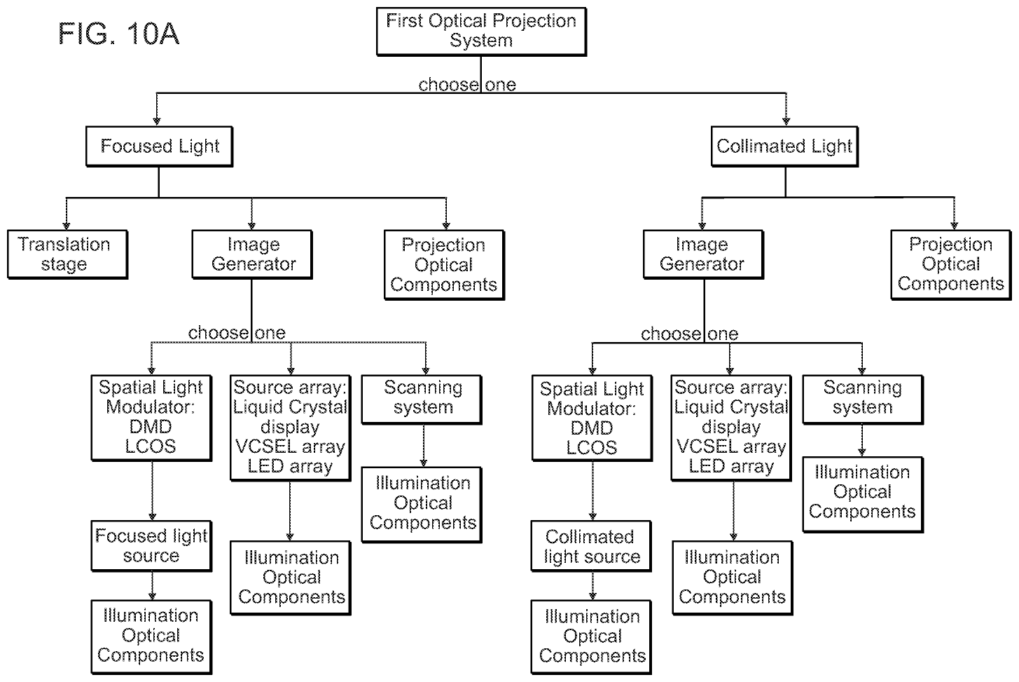

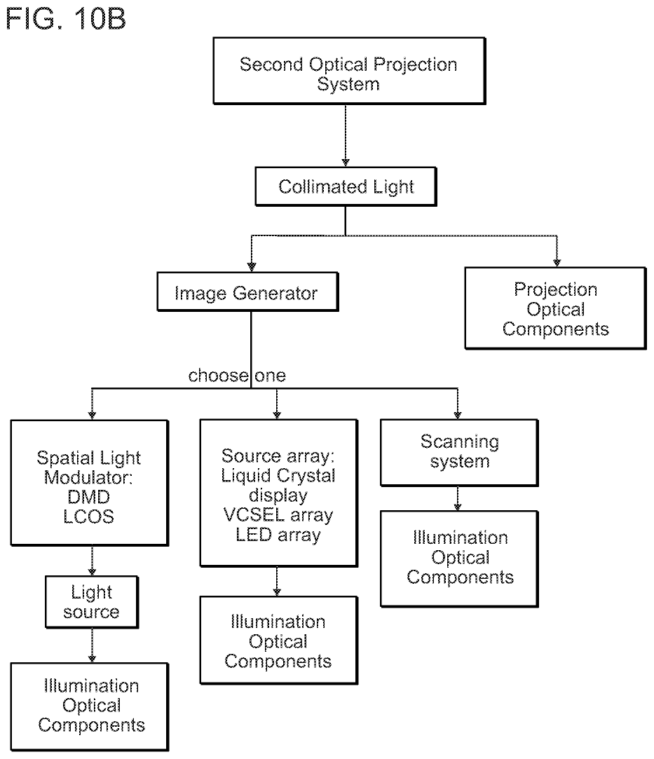

Additional non-limiting examples of first optical projection systems and second optical projection systems for use in one or more aspect of the invention are outlined in FIGS. 10A and 10B.

As discussed herein, methods in accordance with one or more aspects of the invention can include a first optical projection of excitation light that is created by a first optical projection system. A first optical projection of excitation light can be focused or collimated.

FIG. 10A outlines examples of a first optical projection system for use in generating a focused first optical projection. The system can include an image generator, projection optical components (that may include one or more lenses and/or mirrors), and projection optical components. An image generator can include, for example, a spatial light modulator, a focused light source, and illumination optical components. Examples of spatial light modulators include digital micromirror devices and liquid crystal on silicon devices. Another example of an image generator includes a source array in combination with illumination optical components. Examples of source arrays include liquid crystal displays, VCSEL arrays, and LED arrays. Yet another example of an image generator includes a scanning system in combination with illumination optical components. Identification of illumination optical components, scanning systems, and projection optical components for use in the first optical projection system to generate a focused first optical projection is within the skill of the person of ordinary skill in the relevant art.

FIG. 10A also outlines examples of a first optical projection system for use in generating a collimated first optical projection. The system can include an image generator and projection optical components (that may include one or more lenses and/or mirrors). An image generator can include, for example, a spatial light modulator, a collimated light source, and illumination optical components. Examples of spatial light modulators are described above and in FIG. 10A. Another example of an image generator includes a source array in combination with illumination optical components. Examples of source arrays are also listed above and in FIG. 10A. Yet another example of an image generator includes a scanning system in combination with illumination optical components. Identification of illumination optical components, scanning systems, and projection optical components for use in the first optical projection system to generate a collimated first optical projection is within the skill of the person of ordinary skill in the relevant art.

Examples of second optical projection systems for use in one or more aspect of the invention are outlined in FIG. 10B, Methods and systems in accordance with one or more aspects of the invention can include a second optical projection of excitation light that is created by a second optical projection system. A second optical projection of excitation light is preferably collimated.

FIG. 10B outlines examples of second optical projection system for use in generating a collimated second optical projection. The system can include an image generator capable of generating light in a line configuration and projection optical components (that may include one or more lenses and/or mirrors). An image generator capable of generating light in a line configuration can include, for example, a spatial light modulator, a collimated light source, and illumination optical components. Examples of spatial light modulators are described above and in FIG. 10A. Another example of an image generator capable of generating light in a line configuration includes a source array in combination with illumination optical components. Examples of source arrays are also listed above and in FIG. 10A. Yet another example of an image generator capable of generating light in a line configuration includes a scanning system in combination with illumination optical components. Still another example of a second optical projection system is an optical projection system adapted, for example, with an axicon lens or an axisymmetric diffraction grating, for generating a Bessel beam. Identification of illumination optical components, scanning systems, and projection optical components for use in the second optical projection system to generate a collimated second optical projection is within the skill of the person of ordinary skill in the relevant art.

A second optical projection system can optionally include a diffractive optical element.

A second optical projection system can optionally include a cylindrical lens or a power lens.

The first and second optical projection systems are typically used in combination with a computer and software as discussed elsewhere herein. Other components can also optionally be included or used with the system.

A preferred optical projection system for use in the methods described herein includes spatial light modulator projection system including a spatial light modulator and a light source. In a more preferred optical projection system, the spatial light modulator comprises a digital micromirror device. A spatial light modulator projection system typically includes projection optics.

The light used to generate the optical projections of excitation light can be collimated or focused, although an optical projection comprising a sheet of light is preferably generated with use of collimated light.

When collimated excitation is used, the optical projection of excitation light is directed through the volume of photopolymerizable liquid into which it is directed without the need to translationally move the optical projection system to move the optical projection within the volume.

To reduce the number of moving parts during printing, preferably collimated excitation light is used with one, two, or more of the optical projection systems included in the method so that one, two, or more of such systems do not have to be moved in relation to the container during printing and/or the container does not have to be moved relative to the position of the system not using focused illumination.

When focused excitation light is used, the optical projection of excitation light generated with the optical projection system is projected to a selected focus position within the volume of the photopolymerizable liquid, calling for translational movement of the optical projection system or container to move the focus position along the projection axis for printing other portions of the three-dimensional object. If two or more of the optical projection systems use focused excitation light, translational movement of one or more of the optical projection systems and/or the container may be called for to move the focus positions of corresponding focus projections in the photopolymerizable liquid to continue printing the three-dimensional object.

Movement of the systems and/or container may be independently controlled. Movement of the systems and/or container will preferably be coordinated to allow for maximum resolution to be achieved in three dimensions. Maximum resolution can occur, for example, with focused illumination at the focused image plane of each projection.

Method described herein can preferably include two optical projection systems comprising a spatial light modulator and more preferably a digital micromirror device.

One or more of the optical projection systems used and/or the container can optionally be movable in one or more of the x, y, and z directions in relation to any one or more of the others.

Examples of light sources of the excitation light for use in the methods described herein include lasers, laser diodes, light emitting diodes, light-emitting diodes (LEDs), micro-LED arrays, vertical cavity lasers (VCLs), and filtered lamps. Such light sources are commercially available and selection of a suitable light source can be readily made by one of ordinary skill in the relevant art. LEDs of the type such as Phlatlight LEDs available from Luminus for use with DMDs can be preferred.

A light source and be coherent or incoherent. An incoherent light source can be preferred. An incoherent light source is simpler to use and avoids having to address considerations such as, for example, phase and interference considerations, that can arise with use of a coherent light source.

When a photopolymerizable liquid including a photopolymerizable component and photoinitiator is used, the wavelength of light source can be selected based on the absorption characteristics of the photoinitiator in the photopolymerizable liquid.

When an upconverting photopolymerizable liquid is used, the wavelength of light source can be selected based on the absorption characteristics of the upconverting component in the photopolymerizable liquid, as discussed in more detail below. For example, the excitation light including light at the first wavelength for exciting the upconverting component can be preferred.

Excitation light can have a wavelength in the visible or invisible spectral range.

As discussed above, the intensity of an optical projection of excitation light is preferably selected so that a single projection has insufficient intensity to polymerize the photopolymerizable liquid and the intersection of the combination of projections being can achieve polymerization of the photopolymerizable liquid at the intersection.

Power densities or intensities of excitation light directed into the volume of photopolymerizable liquid to cause polymerization to occur may be, without limitation, less than 5,000 W/cm², less than 2000 W/cm², less than 1000 W/cm², less than 500 W/cm², less than 100 W/cm², less than 50 W/cm², less than 10 W/cm², less than 5 W/cm², less than 1 W/cm², less than 500 mW/cm², less than 100 mW/cm², etc.

Most preferably, a nonlinear, such as a quadratic, or higher relationship exists between the power of the excitation light and upconverted emission from the annihilator.

Optionally, the excitation light can be temporally and/or spatially modulated. Optionally, the intensity of the excitation light can be modulated. Optionally, source drive modulation can be used to adjust the absolute power of the light beam.

Spatially modulated excitation light can be created by known spatial modulation techniques, including, for example, a liquid crystal display (LCD), a digital micromirror device (DMD), or a microLED array. Other known spatial modulation techniques can be readily identified by those of ordinary skill in the relevant art.

The optical projection system can be selected to apply continuous excitation light. The optical system can be selected to apply intermittent excitation light. Intermittent excitation can include random on and off application of light or periodic application of light. Examples of periodic application of light includes pulsing. The optical system can be selected to apply a combination of both continuous excitation light and intermittent light, including, for example, an irradiation step that includes the application of intermittent excitation light that is preceded or followed by irradiation with continuous light. Intermittent light may facilitate use of a higher instantaneous light intensity to increase printing speed.

An optical projection system can further include additional components including, but not limited to, projection optics, and one or more translational stages for moving the system or components thereof.

The methods disclosed herein can also include the use commercially available projection and filtering techniques.

Optionally, an optical projection system comprising a spatial light modulator may be utilized, preferably with incoherent light, as an amplitude modulator in combination with projection lens to form an image, e.g., a first optical projection comprising an image, in the photopolymerizable liquid for amplitude based projections.

Optionally, an optical projection system comprising a spatial light modulator may be utilized as a wavefront encoding device to form a phase or complex amplitude modulation on the wavefront in a holographic configuration.

The methods of the invention include a photopolymerizable liquid. A photopolymerizable liquid can include a photopolymerizable component and a photoinitiator that initiates polymerization of the photopolymerizable component upon excitation by light.

Optionally, the photopolymerizable liquid can further include an inhibitor component. An inhibitor can adjust reactivity which can further improve printing resolution, increase shelf life, or other benefits. An example of a preferred inhibitor includes TEMPO radical (2,2,6,6-Tetramethylpiperidin-1-yl)oxyl free radical).

A photoinitiator can be readily selected by one of ordinary skill in the art, considering its suitability for the mechanism to be used to initiate polymerization as well as its suitability for and/or compatibility with the resin or photopolymerizable component to be polymerized. Information concerning photoinitiators that may be useful can be found in WO2019/025717 of Baldeck, et al., published Feb. 7, 2019, and International Application No. Application No. PCT/US2019/063629, of Congreve, et al., filed Nov. 27, 2019, which published as WO 2020/113018 A1on Jun. 4, 2020, each of which is hereby incorporated herein by reference in its entirety. Other considerations in selecting a photoinitiator include the light absorption characteristics of the photoinitiator and the wavelength(s) of the excitation light to be used.

A photopolymerizable component included in the photopolymerizable liquid may be any photopolymerizable resin or monomer suitable for the mechanism to be used to trigger the polymerization (radical mechanism, ionic mechanism, etc.). Examples of photopolymerizable components that may be included in the photopolymerizable liquid include, for example, without limitation, monomers, oligomers or polymers which can be polymerized by the radical route by addition or crosslinking mechanisms such as: acrylated monomers, such as acrylates, polyacrylates, methacrylates, or -acrylated oligomers such as unsaturated amides, or -methacrylated polymers, polymers which have a hydrocarbyl skeleton and pendant peptide groups with a functionality which can be polymerized by free radicals, or vinyl compounds such as styrenes, diallyl phthalate, divinyl succinate, divinyl adipate and divinyl phthalate, or -mixtures of several of the above monomers, oligomers or polymers, cationically polymerizable monomers and oligomers and cationically crosslinkable polymers, for example epoxy resins such as monomeric epoxies and polymeric epoxides having one or more epoxy groups, vinyl ethers, etc. and mixtures of several of these compounds.

Additional information concerning photopolymerization resins and monomers that may be useful can be found in in WO2019/025717 of Baldeck, et al., published Feb. 7, 2019, International Application No. Application No. PCT/US2019/063629, of Congreve, et al., filed Nov. 27, 2019, which published as WO 2020/113018 A1on Jun. 4, 2020, each of which is hereby incorporated herein by reference in its entirety.

Preferably, a photopolymerizable liquid comprises an upconverting photopolymerizable liquid. An upconverting photopolymerizable liquid comprises: (i) a photopolymerizable component; (ii) an upconverting component for absorbing light at a first wavelength and emitting light at a second wavelength, the second wavelength being shorter than the first wavelength; and (iii) a photoinitiator that initiates polymerization of the photopolymerizable component upon excitation by light at the second wavelength.

The photopolymerizable component and photoinitiator are discussed above.

An upconverting component comprises one or more compositions that alone or in combination can absorb light at a first wavelength and emit light at a second wavelength, the second wavelength being shorter than the first wavelength. Preferably the upconverting component exhibits a nonlinear, such as quadratic, intensity dependence for generating upconverted light with respect to light input

An upconverting component can preferably comprise upconverting nanoparticles for absorbing light at a first wavelength and emitting light at a second wavelength, the second wavelength being shorter than the first wavelength. The upconverting nanoparticles preferably include a sensitizer and an annihilator, the sensitizer being selected to absorb light at a first wavelength and the annihilator being selected to emit light at a second wavelength after transfer of energy from the sensitizer to the annihilator, the second wavelength being shorter than the first wavelength. Preferably an upconverting nanoparticle includes a sensitizer and an annihilator.

Upconverting nanoparticles preferably have an average particle size less than the wavelength of the exciting light. Examples of preferred average particle sizes are less than 100 nm, less than 80 nm, less than 50 nm, less than 30 nm, less than 20 nm, although still larger, or smaller, nanoparticles can also be used. Most preferably, the upconverting nanoparticles have an average particle size that creates no appreciable light scattering.

Examples of materials for use as sensitizers and annihilators are described in International Application No. PCT/US2019/063629, of Congreve, et al., filed Nov. 27, 2019, which published as WO 2020/113018 A1on Jun. 4, 2020, S. Sanders, et al., “Photon Upconversion in Aqueous Nanodroplets”, J. Amer. Chem. Soc. 2019, 141, 9180-9184, and Beauti, Sumar, Abstract entitled “Search for New Chromophore Pairs for Triplet-Triplet Annihilation Upconversion” ISEF Projects Database, Finalist Abstract (2017), available at https://abstracts.societyforscience.org, each of the foregoing being hereby incorporated herein by reference in its entirety. WO2019/025717 of Baldeck, et al., published Feb. 7, 2019, and International Application No. PCT/US2019/063629, of Congreve, et al., filed Nov. 27, 2019, which published as WO 2020/113018 A1on Jun. 4, 2020, also provide information that may be useful concerning the concentration of the upconverting nanoparticles and the concentrations of the sensitizer and annihilator in the photopolymerizable liquid.

An annihilator can comprise molecules capable of receiving a triplet exciton from a molecule of the sensitizer through triplet-triplet energy transfer, undergo triplet fusion with another annihilator molecule triplet to generate a higher energy singlet that emits light at a second wavelength to excite the photosensitizer to initiate polymerization of the photopolymerizable component. Examples of annihilators include, but are not limited to, polycyclic aromatic hydrocarbons, e.g., anthracene, anthracene derivatives (e.g., 9,10-bis(triisopropysilyl)ethynyl)anthracene, diphenyl anthracene (DPA) 9,10-dimethylanthracene (DMA), 9,10-dipolyanthracene (DTA), 2-chloro-9,10-diphenylanthracene (DTACI, 2-carbonitrile-9,10-dip tetrylanthracene (DTACN), 2-carbonitrile-9,10-dinaphthylanthracene (DNACN), 2-methyl-9,10-dinaphthylanthracene (DNAMe), 2-chloro-9,10-dinaphthylanthracene (DNACI), 9, 10bis (phenylethynyl) anthracene (BPEA), 2-chloro-9,10bis (phenylethynyl) anthracene (2CBPEA), 5,6,11,12-tetraphenylnaphthacene(rubrene), pyrene and or perylene (e.g., tetra-t-butyl perylene (TTBP). The above anthracene derivatives may also be functionalized with a halogen. Preferred halogenated anthracene derivative include, for example, DPA or 9,10-bis(triisopropysilyl)ethynyl)anthracene further functionalized with a halogen (e.g., fluorine, chlorine, bromine, iodine), more preferably at the 2 or at the 2 and 6 position. Bromine can be a preferred halogen. Fluorescent organic dyes can be preferred.

A sensitizer can comprise at least one molecule capable of passing energy from a singlet state to a triplet state when it absorbs the photonic energy of excitation at the first wavelength. Examples of sensitizers include, but are not limited to, metalloporphyrins (e.g., palladium tetraphenyl tetrabutyl porphyrin (PdTPTBP), platinum octaethyl porphyrin (PtOEP), octaethyl-porphyrin palladium (PdOEP), palladium-tetratolylporphyrin (PdTPP), palladium-meso-tetraphenyltetrabenzoporphyrin 1 (PdPh4TBP), 1,4,8,11,15,18,22,25-octabutoxyphthalocyanine (PdPc (OBu)), 2,3-butanedione (or diacetyl), or a combination of several of the above molecules,). Other examples of sensitizers include osmium sensitizers. See, for example, R. Haruki, et al, Chem. Commun., 2020, Advance Article accepted 13 May 2020 and published 13 May 2020, the abstract of which is available at https://doi.org/10.1039/DOCCO2240C, which paper is hereby incorporated herein by reference.

A consideration in selecting a photosensitizer/annihilator pair may include the compatibility of the pair with the photoinitiator being used.

Preferably upconverting nanoparticles include a core portion that includes the sensitizer and the annihilator in a liquid (e.g., oleic acid) and an encapsulating coating or a shell (e.g., silica) around the outer surface of the core portion. Examples of preferred upconverting nanoparticles include nanocapsules described in International Application No. PCT/US2019/063629, of Congreve, et al., filed Nov. 27, 2019, which published as WO 2020/113018 A1on Jun. 4, 2020, which is hereby incorporated herein by reference in its entirety. Other information concerning nanocapsules that may be useful includes International Publication No. WO2015/059179, of Landfester, et al., which published Apr. 30, 2015, and S. Sanders, et al., “Photon Upconversion in Aqueous Nanodroplets”, J. Amer. Chem. Soc. 2019, 141, 9180-9184, each of which is hereby incorporated herein by reference in its entirety.

Upconverting nanoparticles can further include ligands or functional groups at the surface thereof for facilitating distribution of the nanoparticles in the photopolymerization component. Surfactants and other materials useful as ligands are commercially available. Examples of ligands include, but are not limited to, poly-ethylene glycols.

An upconverting photopolymerizable liquid and other photopolymerizable liquids included in the methods described herein may have any suitable viscosity. For printing a three-dimensional object that is floating within the volume in the container or build chamber, a higher viscosity can be desirable for keeping the object that is being printed suspended. A photopolymerizable liquid having a viscosity of about 1,000 centipoise or higher, 2,000 centipoise or higher, 4,000 centipoise or higher, or even higher can be preferred in this regard. In an embodiment in which a low viscosity photopolymerizable liquid is desirable, the object being printed or formed can attached to a build platform at the outset of printing, for example, by overprinting or curing an attachment to secure the build platform to the part.

The methods in accordance with the present invention are additionally useful for printing 3D objects from photopolymerizable liquids that demonstrate non-Newtonian behavior and which can be solidified at volumetric positions impinged upon by excitation light at a first wavelength by upconversion-induced photopolymerization.

A photopolymerizable liquid may further include additional additives. Examples of such additives include, but are not limited to, thixotropes, oxygen scavengers, etc. WO2019/025717 of Baldeck, et al., published Feb. 7, 2019, provides information that may be useful regarding oxygen scavenger additives.

Preferably, the upconversion achieved by an upconverting photopolymerizable liquid comprises triplet upconversion (or triplet-triplet annihilation, TTA) which may be used to produce light of a higher energy relative to light used to photoexcite the sensitizer or annihilator. Most preferably, the sensitizer absorbs low energy light and upconverts it by transferring energy to the annihilator, where two triplet excitons may combine to produce a higher energy singlet exciton that may emit high-frequency or shorter-wavelength light, e.g., via annihilation upconversion.

The methods of the present invention include providing a volume of a photopolymerizable liquid included within a container wherein at least a portion of the container is optically transparent so that the photopolymerizable liquid is accessible by excitation light. Preferably, the entire container is optically transparent.

Optically transparent portions of a container can be constructed from a material comprising, for example, but not limited to, glass, quartz, fluoropolymers (e.g., Teflon FEP, Teflon AF, Teflon PFA), cyclic olefin copolymers, polymethyl methacrylate (PMMA), polynorbornene, sapphire, or transparent ceramic.

A container can further include filters on its outer surfaces or around the outer surfaces to block certain wavelengths, for example, but not limited to, upconverted light emitted by an upconverting component in an upconverting photopolymerizable liquid, to prevent unintentional photopolymerization.

Examples of container shapes include, but are not limited to, a cylindrical container having a circular or oval cross-section, a container having straight sides with a polygonal cross-section or a rectangular or square cross-section.

Preferably the optically transparent portion(s) of the container is (are) also optically flat.

Preferably the photopolymerizable liquid is degassed, purged or sparged with an inert gas before or after being introduced into the container and is maintained under inert conditions, e.g., under an inert atmosphere, while in the container which is preferably closed during printing. This can prevent introduction of oxygen into the container while the three-dimensional object is being printed or formed. Preferably the container is sealed or otherwise closed in an air-tight manner to prevent introduction of oxygen into the container during printing. The seal or other closing techniques that may be used should not be permanent so at least that the printed objects and unpolymerized material can be removed from the container.

In certain instances, depending, for example, upon the materials used, the photopolymerizable liquid is preferably substantially oxygen free (e.g., less than 50 ppm oxygen, more preferably less than 10 ppm oxygen) during printing.

In the methods described herein, the container may be rotated to provide additional angles of illumination or projection of excitation light into the volume of photopolymerizable liquid contained therein. This can be of assistance in patterning object volumes or surfaces more accurately or it can be used as a means of providing multiple exposure of a given feature from different angles.

In the method described herein, the container may be stationary while an optical projection of excitation light is being directed into the photopolymerizable liquid.

In the methods described herein, optionally more than one three-dimensional object can be formed in the volume of photopolymerizable liquid.

Other information that may be useful in connection with the present invention includes U.S. Patent Application No. 62/911,125 of Congreve, et al., filed Oct. 4, 2019, U.S. Patent Application No. 62/911,128 of Congreve, et al., and International Patent Application No. PCT/US2021/015343 of Quadratic 3D, Inc., filed Jan. 27, 2021. See also U.S. Patent Application No. 63/134,178 of Quadratic 3D, Inc. filed Jan. 5, 2021, relating to improving resolution.

Before printing, a digital file of the object to be printed is typically obtained. If the digital file is not of a format that can be used to print the object, the digital file is then converted to a format that can be used to print the object. An example of a typical format that can be used for printing includes, but is not limited to, an STL file. Typically, the STL file is then sliced into two-dimensional layers with use of three-dimensional slicer software and converted into G-Code or a set of machine commands, which facilitates building the object. See B. Redwood, et al., “The 3D Printing Handbook -Technologies, designs applications”, 3D HUBS B.V. 2018.

Other information concerning optical systems that may useful in connection with the various aspects of the present inventions includes Texas Instruments Application Report DLPA022-July 2010 entitled “DLP™ System Optics”; Texas Instruments “TI DL^{R} Technology for 3D Printing—Design scalable high-speed stereolithograpy [sic] systems using TI DLP technology” 2016; Texas Instruments “DLP6500 0.65 1018p MVSP Type A DMD”, DLP6500, DLPS040A-October 2014— Revised October 2016; and Y-H Lee, et al., “Fabrication of Periodic 3D Nanostructuration for Optical Surfaces by Holographic Two-Photon-Polymerization”, Int'l Journal of Information and Electronics Engineering, Vol 6, No. 3, May 2016, each of the foregoing being hereby incorporated herein by reference in its entirety.

When used as a characteristics of a portion of a container or build chamber, “optically transparent” refers to having high optical transmission to the wavelength of light being used, e.g., the excitation light, and “optically flat” refers to being non-distorting (e.g., optical wavefronts entering the portion of the container or build chamber remain largely unaffected).

As used herein, the singular forms “a”, “an” and “the” include plural unless the context clearly dictates otherwise. Thus, for example, reference to an emissive material includes reference to one or more of such materials.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A method of forming a three-dimensional object, comprising:
a. providing a volume of a photopolymerizable liquid included within a container wherein at least a portion of the container is optically transparent so that the photopolymerizable liquid is accessible by excitation light;
b. directing at least two optical projections of excitation light into the volume of the photopolymerizable liquid, the at least two optical projections of excitation light including a first optical projection of excitation light and a second optical projection of excitation light comprising a sheet of excitation light, wherein each of the first and second optical projections of excitation light is directed into the photopolymerizable liquid in a direction orthogonal to the other and the sheet of excitation light is orthogonal to the direction in which the first optical projection of excitation is directed into the volume, wherein the second optical projection comprises a partial light sheet or stripe of light, and wherein each optical projection of excitation light has an excitation intensity and excitation wavelength so that local polymerization is achieved at the intersection of optical projections of excitation light; and
c. optionally repeating step b wherein the first and second optical projections of excitation light are preferably directed to selected regions within the photopolymerizable liquid, until the desired three-dimensional object is formed.

2. A method of forming a three-dimensional object, comprising:
a. providing a volume of a photopolymerizable liquid included within a container wherein at least a portion of the container is optically transparent so that the photopolymerizable liquid is accessible by excitation light;
b. selectively directing at least two optical projections of excitation light into the volume of the photopolymerizable liquid, the at least two optical projections of excitation light including a first optical projection of excitation light comprising a two-dimensional image and a second optical projection of excitation light comprising a sheet of excitation light, wherein each of the first and second optical projections of excitation light is directed into the volume of the photopolymerizable liquid in a direction orthogonal to the direction of the other and the sheet of excitation light is orthogonal to the direction in which the first optical projection of excitation is directed into the volume, wherein the second optical projection comprises a partial light sheet or stripe of light, and wherein each optical projection of excitation light has an excitation intensity and excitation wavelength so that local polymerization is achieved at the intersection of the first and second optical projections of excitation light; and
c. optionally repeating step b until the desired three-dimensional object is formed.

3. The method of claim 1 wherein the first optical projection of excitation light comprises a two-dimensional image.

4. (canceled)

5. The method of claim 1 wherein the first optical projection of excitation light comprises a single cross-sectional plane of the three-dimensional object.

6-7. (canceled)

8. The method of claim 1 wherein the first optical projection of excitation light comprises a single cross-sectional plane of the three-dimensional object and the second optical projection of excitation light is generated by a second optical projection system comprising a spatial light modulator wherein selected elements are turned on in a “line” configuration to create a line of excitation light that is projected through the photopolymerizable liquid to form a sheet of excitation light orthogonal to the direction in which the first optical projection of excitation light is projected and wherein step c comprises repeating step b until the three-dimensional object is formed, wherein, in a repeated step b, the first optical projection of excitation light comprises a successive single cross-sectional plane of the three-dimensional object being printed and the second optical projection of excitation light comprises a successive sheet of excitation light generated by projecting a line of light created by turning off the spatial light modulator elements for the preceding “line” configuration and turning on the spatial light modulator elements for the successive “line” configuration.

9-14. (canceled)

15. The method of claim 1 wherein the first projection of excitation light is generated by a first optical projection system including collimated excitation light.

16-19. (canceled)

20. The method of claim 1 wherein the second optical projection is generated by a second optical projection system comprising a collimated light source.

21-28. (canceled)

29. The method of claim 1 wherein the first optical projection is generated by a first optical projection system comprising a spatial light modulator.

30. (canceled)

31. The method of claim 1 wherein the first optical projection is generated by a first optical projection system comprising a scanning system.

32. The method of claim 1 wherein the second optical projection is generated by a second optical projection system comprising a spatial light modulator.

33. (canceled)

34. The method of claim 1 wherein the second optical projection is generated by a second optical projection system comprising a scanning system.

35-77. (canceled)

78. The method of claim 1 wherein the partial light sheet or stripe of light are in line with illuminated portions of the first optical projection.

79. The method of claim 1 wherein the second optical projection comprises an array of partial light sheets or stripes of light.

80. The method of claim 79 wherein the partial light sheets or stripes of light of the array are in line with illuminated portions of the first optical projection.

81. (canceled)

82. The method of claim 1 wherein photopolymerization results only at the intersection of the first and second optical projections.

83-84. (canceled)

85. The method of claim 2 wherein the first optical projection of excitation light comprises a two-dimensional image.

86. The method of claim 2 wherein the first optical projection of excitation light comprises a single cross-sectional plane of the three-dimensional object.

87. The method of claim 2 wherein the first optical projection of excitation light comprises a single cross-sectional plane of the three-dimensional object and the second optical projection of excitation light is generated by a second optical projection system comprising a spatial light modulator wherein selected elements are turned on in a “line” configuration to create a line of excitation light that is projected through the photopolymerizable liquid to form a sheet of excitation light orthogonal to the direction in which the first optical projection of excitation light is projected and wherein step c comprises repeating step b until the three-dimensional object is formed, wherein, in a repeated step b, the first optical projection of excitation light comprises a successive single cross-sectional plane of the three-dimensional object being printed and the second optical projection of excitation light comprises a successive sheet of excitation light generated by projecting a line of light created by turning off the spatial light modulator elements for the preceding “line” configuration and turning on the spatial light modulator elements for the successive “line” configuration.

88. The method of claim 2 wherein the first projection of excitation light is generated by a first optical projection system including collimated excitation light.

89. The method of claim 2 wherein the second optical projection is generated by a second optical projection system comprising a collimated light source.

90. The method of claim 2 wherein the first optical projection is generated by a first optical projection system comprising a spatial light modulator.

91. The method of claim 2 wherein the first optical projection is generated by a first optical projection system comprising a scanning system.

92. The method of claim 2 wherein the second optical projection is generated by a second optical projection system comprising a spatial light modulator.

93. The method of claim 2 wherein the second optical projection is generated by a second optical projection system comprising a scanning system.

94. The method of claim 2 wherein the partial light sheet or stripe of light are in line with illuminated portions of the first optical projection.

95. The method of claim 2 wherein the second optical projection comprises an array of partial light sheets or stripes of light.

96. The method of claim 95 wherein the partial light sheets or stripes of light of the array are in line with illuminated portions of the first optical projection.

97. The method of claim 2 wherein photopolymerization results only at the intersection of the first and second optical projections.
